(19) United States
(12) Patent Application Publication
(10) Pub. No.: US 2021/0316379 A1
(43) Pub. Date: Oct. 14, 2021

(54) MATERIAL CUTTING DEVICE

(71) Applicant: THE ERASER COMANY, INC., SYRACUSE, NY (US)

(72) Inventors: Paul Ransiear, Baldwinsville, NY (US); Robert King, Lake Wales, FL (US); Christopher Delia, Deerfield, NY (US); Louis Filo, Pottstown, PA (US); Joan Prieto, Syracuse, NY (US); Daniel Holtz, Chittenango, NY (US)

(73) Assignee: THE ERASER COMPANY, INC., SYRACUSE, NY (US)

(21) Appl. No.: 16/843,444

(22) Filed: Apr. 8, 2020

(51) Int. Cl. B23D 35/00

(52) U.S. Cl. CPC B23D 35/005; B23D 35/002; B23D 35/001

(57) ABSTRACT

A cutting device with the capability of cutting hard materials, such as steels, stainless steels and other similar and exotic alloys. The cutting device includes a cutter head having a central aperture and a stationary body having a channel extending therethrough. The stationary body extends through the central aperture of the cutter head. The cutter head is rotatable between a first configuration and a second configuration relative to the stationary body. The cutting device also includes first and second substantially parallel blades fixed to the stationary body. In the first configuration, the first blade is a first distance from the second blade. In the second configuration, the first blade is a second distance from the second blade. The cutting assembly is connected to a drive mechanism with a driver and an actuator. The actuator connects the cutter head to the driver. Engagement of the driver rotates the actuator, which rotates the cutter head.

### BACKGROUND OF THE INVENTION

### 1. Field of the Invention

The present invention is directed generally to cutting device and, more particularly, to a drive with the capability of cutting hard materials, such as steels, stainless steels and other similar and exotic alloys.

### 2. Description of Related Art

Conventional cutting devices often require numerous rotating structures carrying blades to perform a cutting action. Further, the cutting action, including the movement of the blades, requires manual operation. Manual operation requires a worker and it is likely that the conventional cutting device will not be operating at equal intervals to maximize efficiency.

Therefore, there is a need for cutting device that can cut hard material continuously into pieces having a predetermined length.

### SUMMARY OF THE INVENTION

The present invention is directed to a cutting device with the capability of cutting hard materials, such as steels, stainless steels and other similar and exotic alloys. According to one aspect, the present invention is a cutting assembly. The cutting assembly includes a cutter head having a central aperture and a stationary body with a channel extending therethrough. The stationary body extends through the central aperture of the cutter head. The cutter head is rotatable between a first configuration and a second configuration relative to the stationary body. The cutting device also includes first and second substantially parallel blades fixed to the stationary body. In the first configuration, the first blade is a first distance from the second blade. In the second configuration, the first blade is a second distance from the second blade.

According to another aspect, the present invention is a cutting device. The cutting device includes a cutting assembly having a stationary body with a channel extending therethrough. The stationary body extends through the central aperture of the cutter head. The cutter head is rotatable between a first configuration and a second configuration relative to the stationary body. The cutting assembly additionally includes a first blade fixed to the stationary body and a second blade fixed to the stationary body. The second blade is substantially parallel relative to the first blade. In first configuration, the first blade is a first distance from the second blade. In the second configuration, the first blade is a second distance from the second blade. The cutting device also includes a drive mechanism having a driver connected to an actuator. The driver moves the actuator between a first position and a second position. The actuator is connected to the cutter head such that when the actuator is in the first position, the cutter head is in the first configuration and when the actuator is in the second position, the cutter head is in the second configuration.

According to another aspect, the present invention is method for cutting a material. The method includes the steps of: (i) providing a cutting device including a cutting assembly having a stationary body with a channel extending therethrough, the stationary body extending through the central aperture of the cutter head, wherein the cutter head is rotatable between a first configuration and a second configuration relative to the stationary body, a first blade fixed to the stationary body, a second blade fixed to the stationary body, wherein the second blade is substantially parallel relative to the first blade, wherein in a first configuration, the first blade is a first distance from the second blade, and a drive mechanism having a driver connected to an actuator, wherein the actuator connected to the cutter head; (ii) extending a first material through the channel in the stationary body between the first blade and the second blade in the first configuration; (iii) engaging the driver, causing the actuator to rotate from a first position to a second position; (iv) rotating the cutter head from the first configuration to the second configuration; (v) moving the first blade and the second blade toward each other; and (vi) cutting the first material with the first blade and the second blade.

These and other aspects of the invention will be apparent from and elucidated with reference to the embodiment(s) described hereinafter.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following description taken in conjunction with the accompanying drawings in which:

FIG. 1 is a front perspective view schematic representation of a cutting device, according to an embodiment;

FIG. 2 is an exploded view schematic representation of the cutting assembly, according to an embodiment;

FIG. 3 is a front perspective view schematic representation of the cutting device in the first configuration, according to an embodiment;

FIG. 4 is a front perspective view schematic representation of the cutting device in the second configuration, according to an embodiment;

FIG. 5 is an exploded view schematic representation of the cutting assembly, according to an embodiment;

FIG. 6 is a front perspective view schematic representation of the cutting device in the first configuration, according to an embodiment; and

FIG. 7 is another front perspective view schematic representation of the cutting device in the first configuration, according to an embodiment

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

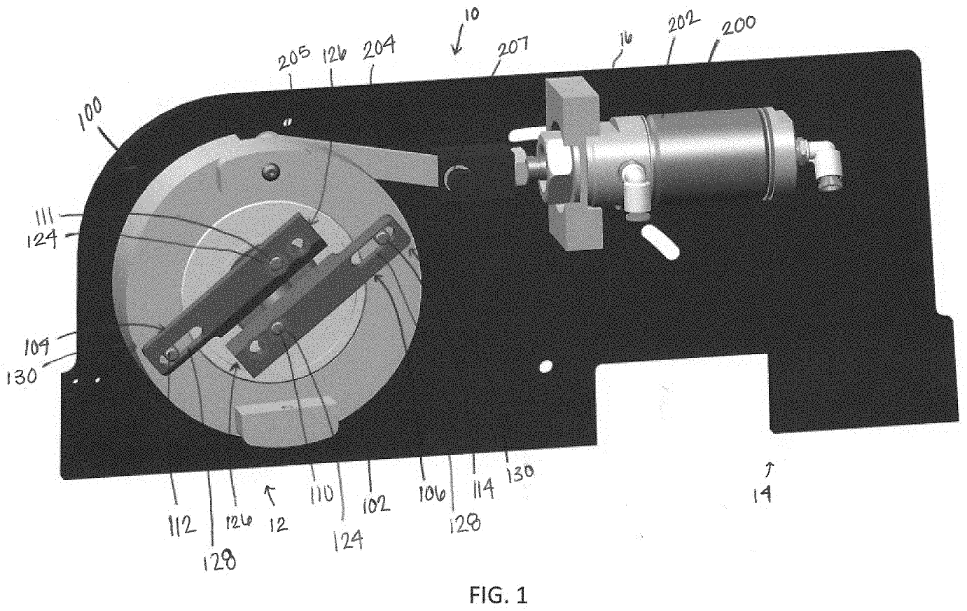

Referring now to the figures, wherein like reference numerals refer to like parts throughout, FIG. 1 shows a front perspective view schematic representation of a cutting device 10, according to an embodiment. The cutting device 10 comprises a first end 12 and a second end 14. The cutting device 10 may include a housing 16 such that one or more components of the cutting device 10 are contained within the housing 16. At the first end 12, the cutting device 10 includes a cutting assembly 100. The cutting assembly 100 comprises a cutter head 102. The cutter head 102 in FIG. 1 is circular, although any shape and/or configuration of the cutter head 102 can be used.

As also shown in FIG. 1, the cutting assembly 100 includes a pair of blades, a first blade 104 and a second blade 106, attached to the cutter head 102. The cutter head 102 is movable such that rotation of the cutter head 102 causes the first blade 104 and the second blade 106 move relative to each other. The cutting assembly 100 is connected to a driving mechanism 200 at the second end 14 of the cutting device 10.

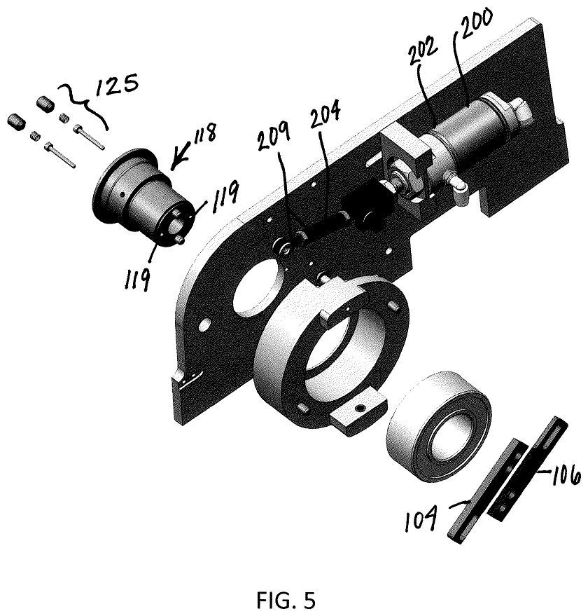

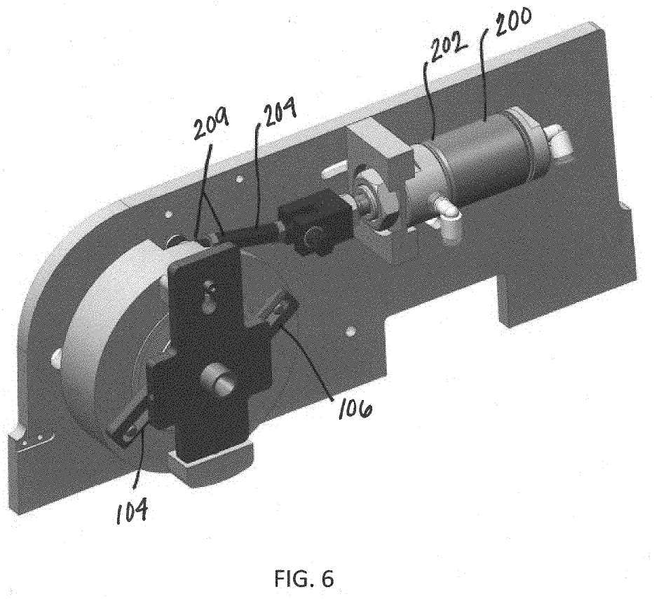

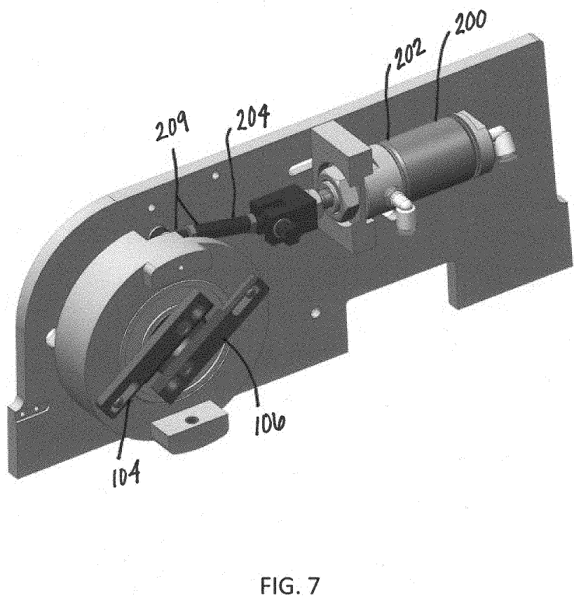

In FIG. 1, the driving mechanism 200 comprises a driver 202 connected to an actuator 204. The actuator 204 is connected to or in contact with cutting assembly 100. The driver 202 powers the actuator 204 to rotate the cutter head 102, thereby moving the first and second blades 104, 106 relative to each other. In the depicted embodiment, the driver 202 is an air cylinder; however, the driver 202 can be any other type of known pneumatic, hydraulic, or electric system for powering and moving the actuator 204. As also shown in FIG. 1, the actuator 204 is an elongated arm with a first end 205 attached to the cutting assembly 100 and a second end 207 connected to the driver 202. In an embodiment, the actuator 204 is adjustable such that the length of the actuator 204 can be positively adjusted or negative adjusted. In particular, the actuator 204 can have a telescoping mechanism 209, such as sections with internal threads that are configured to mate to either extend or retract a section of the actuator 204, as shown in FIGS. 5-7.

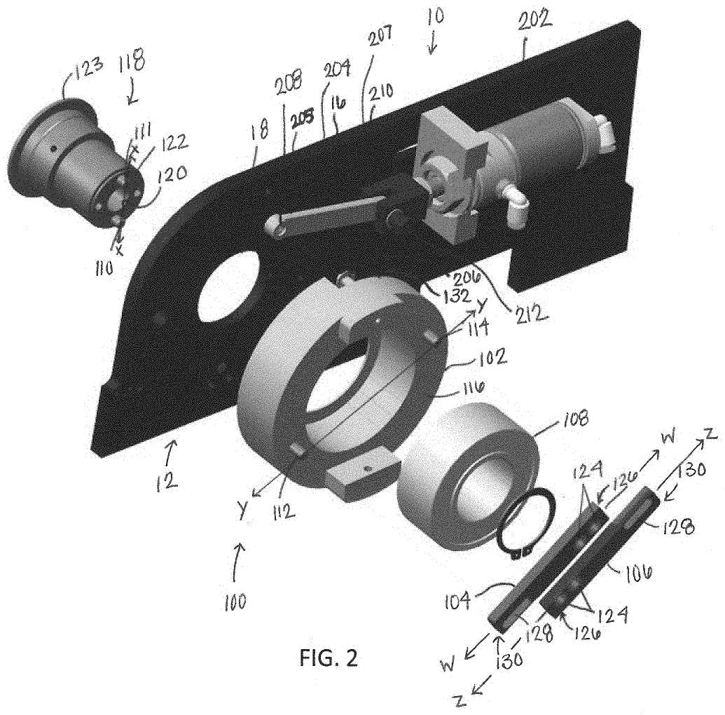

Turning now to FIG. 2, there is shown an exploded view schematic representation of the cutting assembly 100 according to an embodiment. The cutting assembly 100 includes the cutter head 102, which is ring-shaped with an inner diameter. The cutting assembly 100 additionally comprises a ring-shaped bearing 108, which is sized and configured to fit within the inner diameter of the cutter head 102.

Still referring to FIG. 2, the first and second blades 104, 106 are attached to the cutter head 102 via conventional connectors. In the depicted embodiment, the connectors are pins. Specifically, the cutter head 102 comprises a first pin 112 and a second pin 114 extending from a first side 116 of the cutter head 102. As shown in FIG. 2, the first pin 112 and the second pin 114 are in alignment such that an axis y-y extending from the first pin 112 to the second pin 114 extends across the inner diameter of the cutter head 102.

The cutting assembly 100 additionally comprises a stationary body 118. In the depicted embodiment, the stationary body 118 is a bushing sleeve. The bushing sleeve 118 comprises a central channel 120 extending therethrough such that the bushing sleeve 118 has an inner diameter. The channel 120 is sized and configured to fit the desired material for cutting. The bushing sleeve 118 additionally comprises a first side 122 with a first pin 110 and a second pin 111 extending therefrom. As shown in FIG. 2, the first pin 110 and the second pin 111 on the bushing sleeve 118 are in alignment such that an axis x-x extending from the first pin 110 to the second pin 111 extends across the inner diameter of the bushing sleeve 118.

The first side 122 of the bushing sleeve 118 comprises a first outer diameter sized and configured to fit within the inner diameter of the bearing 108, as shown in FIG. 1. As also shown in the depicted embodiment, the cutting device 10 comprises a housing 16 with an aperture 18 at its first end 12. The bushing sleeve 118 is sized and configured to fit through the aperture 18 in the housing 16. However, the bushing sleeve 118 comprises a second outer diameter on its second side 123 that is larger than the aperture 18 in the housing 16 such that at least a portion of the bushing sleeve 118 remains on an opposing side of the housing 16.

Still referring to FIG. 1, the first and second blades 104, 106 are connected to the cutting assembly 100 via the first and second pins 110, 111 on the bushing sleeve 118 and the first and second pins 112, 114 on the cutter head 102. Specifically, the first and second blades 104, 106 each comprise one or more apertures 124 at a first end 126 of the second blades 104, 106 and a slot 128 at a second end 130 of the second blades 104, 106. As shown in FIG. 1, the second pin 111 on the bushing sleeve 118 extends through an aperture 124 at the first end 126 of the first blade 104 and the first pin 110 on the bushing sleeve 118 extends through an aperture 124 at the first end 126 of the second blade 106. Additionally, the first pin 112 on the cutter head 102 extends through the slot 128 at the second end 130 of the first blade 104. Similarly, the second pin 114 on the cutter head 102 extends through the slot 128 at the second end 130 of the second blade 106.

Turning back to FIG. 2, an axis w-w extends along a length of the first blade 104 from the first pin 112 on the cutter head 102 to the first pin 110 on the bushing sleeve 118 and an axis z-z extends along a length of the second blade 106 from the second pin 111 on the bushing sleeve 118 to the second pin 114 on the cutter head 102. In the depicted embodiment, the axis w-w extending along the first blade 104 is substantially parallel to the axis z-z extending along the second blade 106.

Still referring to FIG. 2, the cutter head 102 is connected to the actuator 204 via a rearward pin 206; however, any known connectors can be used. In the depicted embodiment, the rearward pin 206 extends from a second side 132 of the cutter head 102. The rearward pin 206 on the cutter head 102 extends through and connects to an aperture 208 in the first end 205 of the elongated arm 204. The second end 207 of the elongated arm 204 is attached to an adapter 210 on the air cylinder 202, as shown. In the depicted embodiment, the second end 207 of the elongated arm 204 is attached to the adapter 210 via an adapter pin 212. The elongated arm 204 is attached to the adapter 210 such that the elongated arm 204 is rotatable or otherwise movable between a first position and a second position.

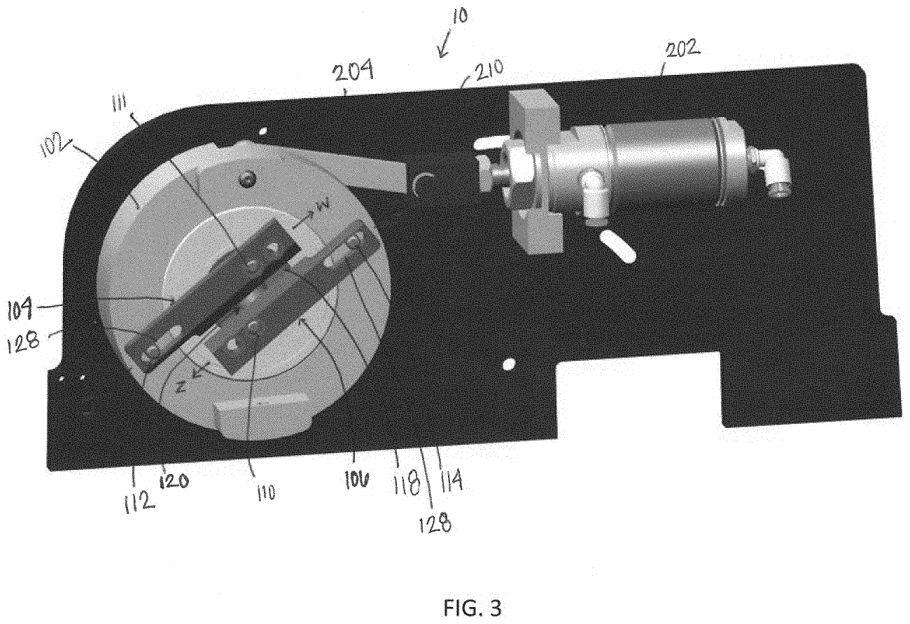

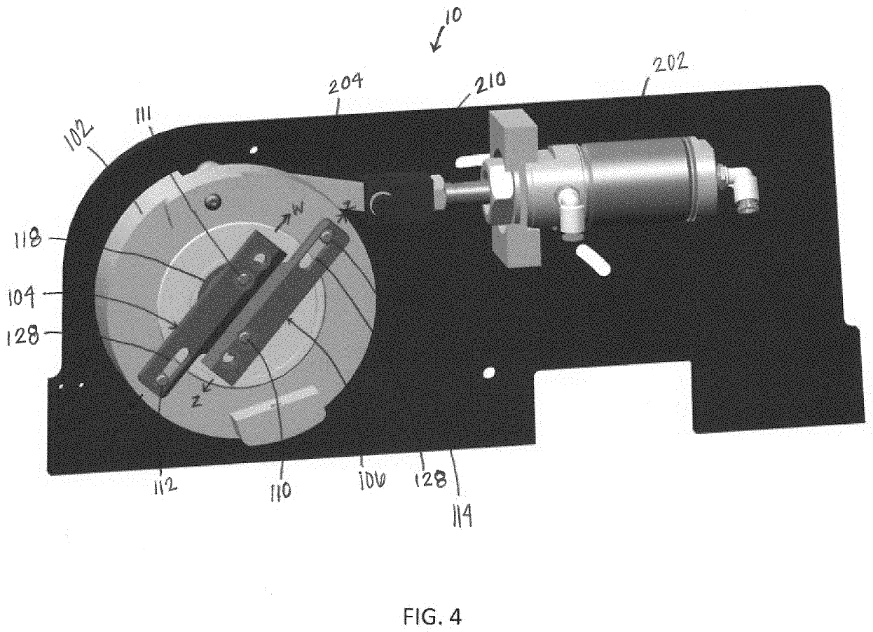

Referring now to FIGS. 3 and 4, there are shown front perspective views schematic representations of the cutting device 10 in an open configuration and a closed configuration, respectively, according to an embodiment. In the open configuration, shown in FIG. 3, the actuator 204 is in the first position relative to the adapter 210 (or the drive mechanism 200 generally). Additionally, when the cutting device 10 is in the first configuration, the first blade 104 is a first distance from the second blade 106. Stated differently, the axis w-w extending through the first blade 104 is a first distance from the axis z-z extending through the second blade 106. Thus, the first blade 104 and the second blade 106 are slightly offset (e.g., hundredths of an inch). The first and second blades 104, 106 can be maintained in a slightly offset relationship using any known connectors. In one embodiment, shown in FIGS. 5-7, a springed pin assembly 125 is passed through an aperture 119 in the bushing sleeve 118. Additional springed pin assemblies 125 may be used if additional apertures 119 are present in the bushing sleeve 118. Preferably, there are two springed pin assemblies 125, one extending through each of two apertures 119 in the bushing sleeve 118. The springed pin assemblies 125 press against the sides of each blade 104, 106 to apply pressure to keep the blades 104, 106 slightly offset.

In the open configuration, as shown in FIG. 3, the desired material is fed through the channel 120 in the bushing sleeve 118 and between the first and second blades 104, 106. When a desired amount of material has been passed between the first and second blades 104, 106, the cutting device 10 is moved to the second configuration to cut the material. In order to move the cutting device 10 from the first configuration to the second configuration, the driver 202 moves the actuator 204 from the first position to the second position.

As recited above, the actuator 204 rotates from the first position to the second position. As the actuator 204 is attached to the cutter head 102, as shown in FIG. 2, movement of the actuator 204 from the first position to the second position, rotates the cutter head 102. In the depicted embodiment, the cutter head 102 is rotated counterclockwise when the actuator 204 moves from the first position to the second position. When the cutter head 102 is rotated, the first blade 104 rotates because the first blade 104 is attached to the second pin 111 of the stationary bushing sleeve 118 and the second blade 106 rotates because the second blade 106 is attached to the first pin 110 of the stationary bushing sleeve 118.

As the first blade 104 and the second blade 106 rotate with the cutter head 102 in a counterclockwise fashion, the first blade 104 rotates as the first pin 112 of the cutter head 102 slides toward an outer end of the slot 128 and the second blade 106 rotates as the second pin 114 of the cutter head 102 slides toward an outer end of the slot 128. In other words, the slots 128 on the first and second blades 104, 106 allow for or accommodate a limited amount of movement of the first and second blades 104, 106. Ultimately, the movement of the first and second blades 104, 106 is limited by movement of the driver 202 (e.g., the stroke of the air cylinder). Thus, as the cutter head 102 is rotated, the first and second blades 104, 106 rotate with the cutter head 102 as the first pin 112 and the second pin 114 move toward the outer end of the slots 128 until their motion is limited by the driver 202, as shown in FIG. 4. In the second configuration shown in FIG. 4, the first blade 104 is a second distance from the second blade 106. Stated differently, the axis w-w extending through the first blade 104 is a second distance from the axis z-z extending through the second blade 106. Generally, the second distance is less than the first distance. Ideally, the second distance, when measured between the first blade 104 and second blade 106, is zero in the second configuration. However, in an alternative embodiment the first and second blades 104, 106 may pass, such that the second distance is negative. The distance between the blades 104, 106 is adjustable such that the first and second distance can be fine-tuned or otherwise adapted for a specific material. After the desired material is passed through the cutter head 102 when the cutting device 10 is in the first configuration, rotation of the cutter head 102 causes the second blades 104, 106 to move toward each other to the second configuration where the desired material is cut. Thus, the second distance must be such that a portion of the desired material is cut.

The cutting device 10 can be connected to a computing system (not shown) such that the rotation of the cutter head 102 is programmable. For example, the driver mechanism 202 can be programmed to rotate the cutter head 102 a specific number of rotations per a time period or programmed to start/end rotations at a specific time.

All definitions, as defined and used herein, should be understood to control over dictionary definitions, definitions in documents incorporated by reference, and/or ordinary meanings of the defined terms.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. A cutting assembly, comprising:
a cutter head having a central aperture;
a stationary body having a channel extending therethrough, the stationary body extending through the central aperture of the cutter head;
wherein the cutter head is rotatable between a first configuration and a second configuration relative to the stationary body;
a first blade fixed to the stationary body
a second blade fixed to the stationary body, the second blade substantially parallel relative to the first blade;
wherein in the first configuration, the first blade is a first distance from the second blade, and in the second configuration, the first blade is a second distance from the second blade.

2. The assembly of claim 1, wherein the second distance is less than the first distance.

3. The assembly of claim 1, further comprising a first pin and a second pin on the cutter head.

4. The assembly of claim 3, further comprising a slot in the first blade and a slot in the second blade.

5. The assembly of claim 4, wherein rotation of the cutter head between the first configuration and the second configuration moves the slot in the first blade relative to the first pin and moves the slot in the second blade relative to the second pin.

6. The assembly of claim 1, further comprising a bearing within the central aperture of the cutter head between the cutter head and the stationary body.

7. A cutting device, comprising:
a cutting assembly having:
a cutter head having a central aperture;
a stationary body having a channel extending therethrough, the stationary body extending through the central aperture of the cutter head;
wherein the cutter head is rotatable between a first configuration and a second configuration relative to the stationary body;
a first blade fixed to the stationary body
a second blade fixed to the stationary body, the second blade substantially parallel relative to the first blade;
wherein in the first configuration, the first blade is a first distance from the second blade, and in the second configuration, the first blade is a second distance from the second blade;
a drive mechanism having:
a driver connected to an actuator, the actuator connected to the cutter head; and
wherein the driver moves the actuator between a first position and a second position; and
wherein when the actuator is in the first position, the cutter head is in the first configuration and when the actuator is in the second position, the cutter head is in the second configuration.

8. The cutting device of claim 7, wherein the cutting assembly and the drive mechanism are connected within a housing.

9. The cutting device of claim 8, further comprising an aperture in a first end of the housing.

10. The cutting device of claim 9, wherein a portion of the stationary body extends through the aperture in the first end of the housing.

11. The cutting device of claim 7, wherein the actuator is an elongated arm.

12. The cutting device of claim 7, wherein the driver is an air cylinder.

13. The cutting device of claim 7, further comprising a bearing within the central aperture of the cutter head between the cutter head and the stationary body.

14. The cutting device of claim 7, further comprising a first pin and a second pin on the cutter head.

15. The cutting device of claim 14, further comprising a slot in the first blade and a slot in the second blade.

16. The cutting device of claim 15, wherein rotation of the cutter head between the first configuration and the second configuration moves the slot in the first blade relative to the first pin and moves the slot in the second blade relative to the second pin.

17. A method for cutting material, comprising the steps of:
providing a cutting device including a cutting assembly having a cutter head having a central aperture, a stationary body with a channel extending therethrough, the stationary body extending through the central aperture of the cutter head, wherein the cutter head is rotatable between a first configuration and a second configuration relative to the stationary body, a first blade fixed to the stationary body, a second blade fixed to the stationary body, wherein the second blade is substantially parallel relative to the first blade, wherein in a first configuration, the first blade is a first distance from the second blade, and a drive mechanism having a driver connected to an actuator, wherein the actuator connected to the cutter head;
extending a first material through the channel in the stationary body between the first blade and the second blade in the first configuration;
engaging the driver, causing the actuator to rotate from a first position to a second position;
rotating the cutter head from the first configuration to the second configuration;
moving the first blade and the second blade toward each other; and
cutting the first material with the first blade and the second blade.

18. The method of claim 17, further comprising the step of engaging the driver, causing the actuator to rotate from the second position to the first position.

19. The method of claim 18, further comprising the step of rotating the cutter head from the second configuration to the first configuration.

20. The method of claim 19, further comprising the steps of:
moving the first blade and the second blade away from each other; and
extending a second material through the channel in the stationary body between the first blade and the second blade in the first configuration.
